(19) United States
(12) Patent Application Publication
(10) Pub. No.: US 2025/0035144 A1
(43) Pub. Date: Jan. 30, 2025

(54) METHOD OF USING SPRING LOADED LATCH LOCK CLAMPS TO ASSEMBLE FURNITURE

(71) Applicant: Abble, Inc., Rancho Cucamonga, CA (US)

(72) Inventor: Chang YANG, Rancho Cucamonga, CA (US)

(73) Assignee: Abble, Inc., Rancho Cucamonga, CA (US)

(21) Appl. No.: 18/357,708

(22) Filed: Jul. 24, 2023

(51) Int. Cl. F16B 12/20; A47B 3/12; A47B 13/02; A47C 4/02

(52) U.S. Cl. CPC F16B 12/2009; A47B 3/12; A47B 13/021; A47C 4/028; A47C 17/02; F16B 2012/209

(57) ABSTRACT

A method of assembling a furniture piece includes aligning a first side end with a first side of a frame, inserting a plurality of alignment pins on the first side into a plurality of alignment holes on the first side end, latching a plurality of spring-loaded latches on the first side end with a plurality of receivers on the first side of the frame, aligning a second side end with a second side of the frame, inserting a plurality of alignment pins on the second side into a plurality of alignment holes on the second side end and latching a plurality of spring-loaded latches on the second side end with a plurality of receivers on the second side of the frame.

### TECHNICAL FIELD

This disclosure relates generally to a method for assembling furniture using spring-loaded latch clamps.

### BACKGROUND

Furniture pieces such as tables and chairs are often large and bulky. The size and shape of these pieces make it difficult or expensive to ship these products to consumers, requiring large boxes or plastic wrapping to protect the furniture in transit, shipping companies or trucks that are specific for the delivery of said pieces, and a person or group or people who can carry and move the heavy furniture.

The large furniture pieces additionally challenge consumers who desire to store the furniture when not in use. For example, outdoor furniture may need to be stored during harsh, winter months to prevent damage to the furniture. Storing said furniture without disassembling the furniture requires ample amount of indoor and/or protected space which many owners may lack.

Many furniture pieces are able to be disassembled for ease of said problems. However, the process to assemble and disassemble furniture pieces tends to be difficult, requiring tools and significant time and energy to assemble. Additionally, while some pieces are delivered to a user disassembled for ease in delivery, once assembled they may be difficult to disassemble or even may damage parts if a consumer disassembles the furniture.

Therefore, a need exists for an improved knock-down furniture design which can be disassembled and assembled with ease.

### OVERVIEW

According to the disclosure, a furniture piece includes a table having a tabletop and a frame and a pair of side ends removably attached to opposing sides of the frame. The frame may include at least two alignment pins and at least two receivers. Each side end of the pair of side ends includes at least one alignment hole and at least one spring-loaded latch. When the frame and the pair of side ends are in an assembled position, an alignment pin of the at least two alignment pins is insertable into a respective alignment hole of the at least two alignment holes and a spring-loaded latch of the at least one spring-loaded latch is positioned such that the latch is tight around a receiver of the at least one receiver.

Also, according to the disclosure, a furniture piece includes a frame having a seat back and a seat bottom, a pair of side ends removably attached to opposing sides of the frame, and a frame front surface. The seat back and the seat bottom include at least three alignment pins and at least three receivers. Each side end of the pair of side ends includes at least two alignment holes and at least two spring-loaded latches. The frame front surface includes at least two alignment pins, at least one alignment hole, at least two receivers, and at least one spring-loaded latch. When the frame, the pair of side ends, and the frame front surface are in an assembled position, each alignment pin is insertable in a respective alignment hole, and each receiver is receivable in a respective spring-loaded latch.

According to the disclosure, a method of assembling a furniture piece includes aligning a first side end with a first side of a frame, inserting a plurality of alignment pins on the first side into a plurality of alignment holes on the first side end, latching a plurality of spring-loaded latches on the first side end with a plurality of receivers on the first side of the frame, aligning a second side end with a second side of the frame, inserting a plurality of alignment pins on the second side into a plurality of alignment holes on the second side end and latching a plurality of spring-loaded latches on the second side end with a plurality of receivers on the second side of the frame.

### BRIEF DESCRIPTION OF THE DRAWINGS

FIG. 1 is a schematic view generally illustrating an exemplary piece of furniture configured as a table;

FIG. 2A is a schematic view generally illustrate an exemplary piece of furniture configured as a table in an assembled position;

FIG. 2B is a schematic view generally illustrate an exemplary piece of furniture configured as a table in an unassembled position;

FIG. 3 is a schematic view generally illustrating an exemplary piece of furniture configured as a sofa;

FIG. 4A is a schematic view generally illustrate an exemplary piece of furniture configured as a sofa in an assembled position;

FIG. 4B is a schematic view generally illustrate an exemplary piece of furniture configured as a sofa in an unassembled position;

FIG. 5 is a schematic view generally illustrating an exemplary piece of furniture configured as a chair;

FIG. 6A is a schematic view generally illustrate an exemplary piece of furniture configured as a chair in an assembled position;

FIG. 6B is a schematic view generally illustrate an exemplary piece of furniture configured as a chair in an unassembled position;

FIG. 7A is a schematic front view generally illustrating an exemplary receiver;

FIG. 7B is a schematic side view generally illustrating an exemplary receiver;

FIG. 7C is a schematic rear view generally illustrating an exemplary receiver;

FIG. 8A is a schematic front view generally illustrating an exemplary spring-loaded latch in a closed position;

FIG. 8B is a schematic side view generally illustrating an exemplary spring-loaded latch in a closed position;

FIG. 8C is a schematic rear view generally illustrating an exemplary spring-loaded latch in a closed position;

FIG. 8D is a schematic perspective view generally illustrating an exemplary spring-loaded latch in an open position;

FIG. 9 is a flow diagram illustrating the operation of an exemplary spring-loaded latch;

FIG. 10 is a flow diagram illustrating the operation of an exemplary alignment pin and hole assembly;

FIG. 11A is a schematic view generally illustrating a method of aligning a pin and hole assembly;

FIG. 11B is a schematic view generally illustrating an inserted pin and hole assembly;

FIG. 11C is a schematic view generally illustrating a method of latching a spring-loaded latch and receiver; and

FIG. 11D is a schematic view generally illustrating a latched spring-loaded latch and receiver.

### DESCRIPTION

Referring now to the discussion that follows and the drawings, illustrative approaches to the disclosed systems and methods are described in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive, otherwise limit, or restrict the claims to the precise forms and configurations shown in the drawings and disclosed in the following detailed description.

This disclosure relates generally to a furniture piece having a knock-down construction and the method of assembling the furniture piece.

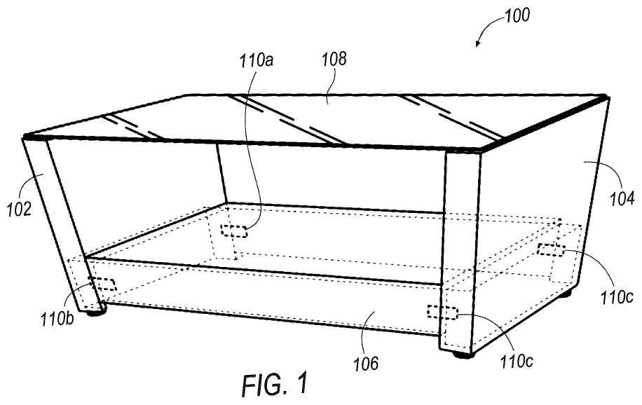

As generally illustrated in FIG. 1, a furniture piece may be configured as a table 100, but it will be appreciated that any type of furniture piece could be contemplated by this disclosure. The exemplary table 100 includes a tabletop 108 and a frame 106. Table 100 also includes a first side end 102 and a second side end 104. First side end 102 and second side end 104 are removably attached to opposing sides of frame 106. Tabletop 108 may be removably attached to frame 106. In a disassembled position, table 100 may be broken down into, for example, four pieces (e.g., frame 106, tabletop 108, first side end 102, and second side end 104). Each of the disassembled pieces may be assembled via a plurality of connection points 110.

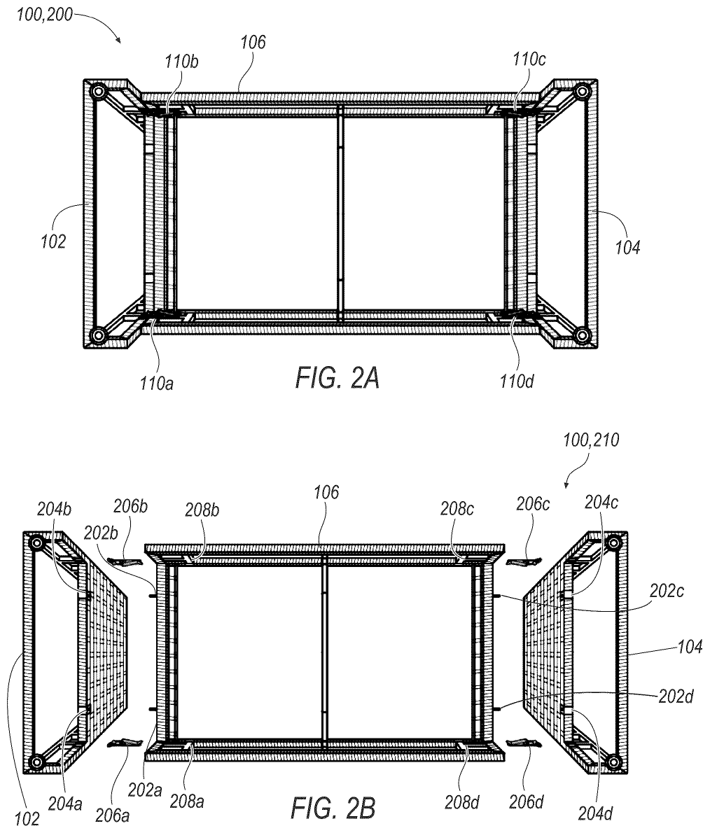

FIG. 2A illustrates an exemplary table 100 in an assembled position 200 from a bottom view. FIG. 2B illustrates the exemplary table 100 in a disassembled position 210 from a bottom view. As shown in FIG. 2A, first side end 102, second side end 104, and frame 106 are connected at connection points 110. In the exemplary configuration, first side end 102 is attached to frame 106 at a first connection point 110A and a second connection point 110B. Second side end 104 is attached to frame 106 at a third connection point 110C and a fourth connection point 110D. Frame 106 and each of first side end 102 and second side end 104 include two connection points 110 in the illustrated table 100, however only one connection point 110 per side end is required and more connection points may be added to secure larger tables.

As illustrated in FIG. 2B, connection points 110 include an alignment connection and a latching connection. For example, alignment connection includes an alignment pin 202 and an alignment hole 204. Frame 106 includes a first two alignment pins (e.g., 202A, 202B) which are insertable into a first two alignment holes (e.g., 204A, 204B) on first side end 102 and a second two alignment pins (e.g., 202C, 202D) which are insertable into alignment holes (e.g., 204C, 204D) on second side end 104. In other embodiments, frame 106 includes at least one alignment pin 202 insertable into each of the pair of side ends 102, 104 such that only two alignment pins 202 are necessary, however more alignment connections may be added and used. Alignment pins 202 and alignment holes 204 are provided for ease of aligning each of disassembled pieces such that they may be positioned and secured in a correct position. Latching connection of connection point 110 includes a spring-loaded latch 206 and a respective receiver 208. Frame 106 includes a first two receivers (e.g., 208A, 208B) which are positioned to receive a first two spring-loaded latches (e.g., 206A, 206B) on first side end 102 and a second two receivers (e.g., 208C, 208D) which are positioned to receive a second two spring-loaded latches (e.g., 206C, 206C) on second side end 104. It will be appreciated that the spring-loaded latches 206 may be positioned on the ends 102 and 104, while the receivers 208 may be located on the frame 106. In other embodiments, frame 106 includes at least one receiver 208 for receiving at least one spring-loaded latch 206 one each side end of the pair of side ends 102, 104, such that only two latches 206 are necessary, however more latch connections may be added and used.

Thus, according to an embodiment, wherein the furniture piece is a configured as a table 100, the furniture piece includes a tabletop 108 and a frame 106 and a pair of side ends 102, 104 removably attached to opposing sides of the frame 106. The frame includes at least two alignment pins 202 and two receivers 208. Each side end of the pair of side ends 102, 104 includes at least one alignment hole 204 and at least one spring-loaded latch 206. In an assembled position, each of the at least two alignment pins 202 are inserted into a respective alignment hole 204 of the at least two alignment holes 204 and each of the at least two spring-loaded latches 206 are positioned such that the latch 206 is tight around a respective receiver 208 of the at least two receivers 208.

As illustrated in FIG. 1, the table 100 includes tabletop 108. Tabletop 108 is removably attached to frame 106, but may also be integrated into frame 106. In an embodiment such that tabletop 108 is an additional disassemble piece, tabletop 108 includes at least two alignment pins 202 on a bottom surface of tabletop 108. Alignment pins 202 may be insertable into alignment holes 204 on a top surface of frame 106 such that in an assembled position, tabletop 108 is positioned and rests on frame 106. Tabletop 108 may include a latching connection including a spring-loaded latch 206 that is configured to secure to a receiver 208 positioned on frame 106.

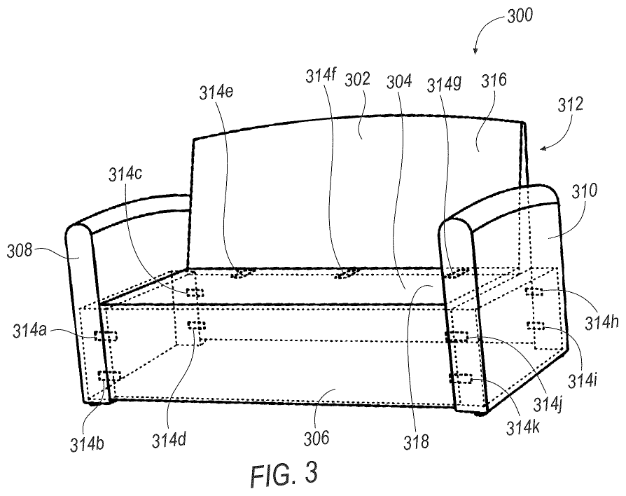

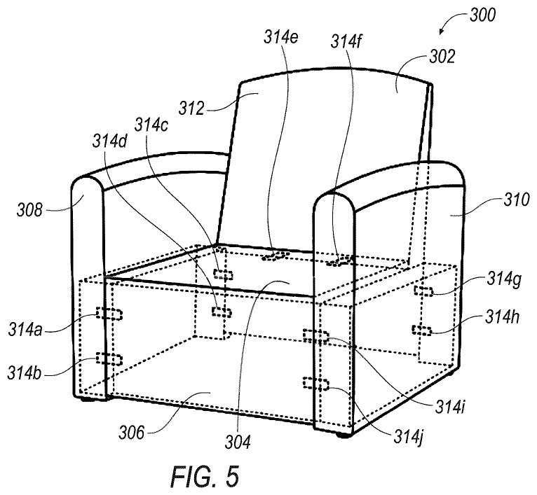

As generally illustrated in FIGS. 3 and 5, a furniture piece may be configured as a sofa 300. The exemplary sofa 300 includes a frame 312 with a seat back 302 and a seat bottom 304, a frame front surface 306, a first side end 308 and a second side end 310. First side end 308 and second side end 310 are removable attached to opposing sides of frame 312. Frame front surface 306 is removably attached to a front of frame 312, perpendicular to front side end 308 and second side end 312. In a disassembled position, sofa 300 may be broken down into, for example, four pieces including the frame 312, first side end 308, second side end 310, and frame front surface 306. Each of disassembled pieces may be assembled via a plurality of connection points 314.

As illustrated in FIG. 3 and FIG. 5, the length (e.g., in the x-direction) of the frame 312 and the length (e.g., in the x-direction) of the frame front surface 306 are equal. The length (e.g., in the z-direction) of the front side end 308 is the same length (e.g., in the z-direction) of the second side end 310. The length of the frame 312 and the frame front surface 306 are extendable and may include additional pieces or be constructed of different lengths. For example, frame 312 and frame front surface 306 may be of a larger length to form a sofa or longer seating surface as illustrated in FIG. 3. The frame 312 and frame front surface 306 may include a shorter length to form a chair or a shorter seating surface as illustrated in FIG. 5. Longer seating surfaces may include additional alignment connections and/or latching connections to provide additional stability to seating surface. In an assembled position, a back cushion 316 and a bottom cushion 318 (FIG. 3) are connected to the seat back 302 and the seat bottom 304 to provide comfort to the seating surface.

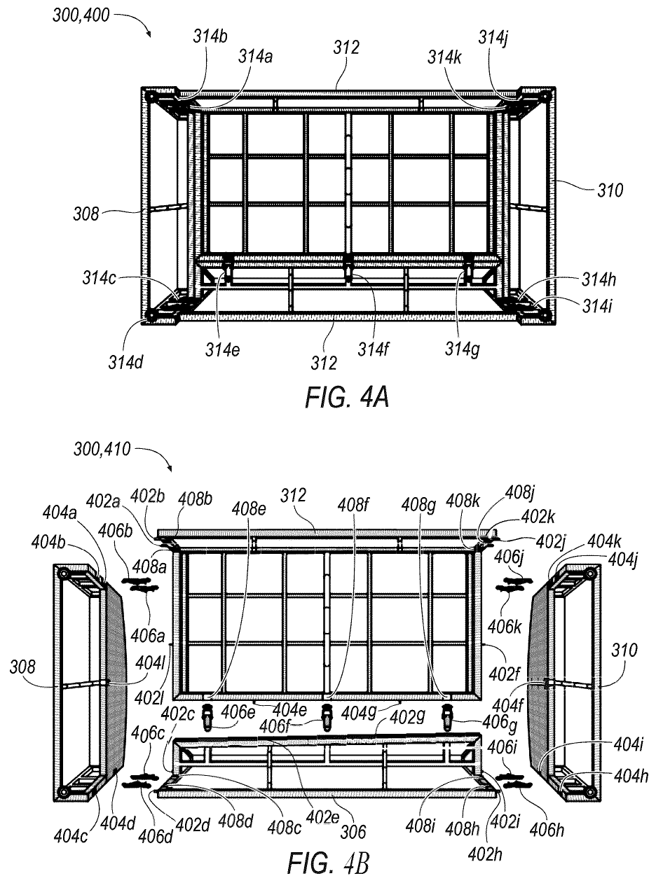

FIG. 4A illustrates an exemplary sofa 300 in an assembled positioned 400 from a bottom view and FIG. 4B illustrates an exemplary sofa 300 in a disassembled position 410 from a bottom view. As shown in FIG. 4A, first side end 308, second side end 310, frame 312, and frame front surface 306 are connected at connection points 314. In the exemplary configuration, first side end 308 is connected to frame 312 via connection point 314 and is connected to frame front surface 306 via connection point 314. Second side end 310 is connected to frame 312 via connection point 314 and is connected to frame front surface 306 via connection point 314. Frame front surface 306 is connected to frame 312 (e.g., at seat bottom 304) via connection points 314. Each connection point may include at least one alignment connection and at least one latching connection, however more than one may be used to strengthen the assembly of each piece.

As illustrated in FIG. 4B, connection points 314 include alignment connections and latching connections. For example, alignment connections include alignment pins 402, and alignment holes 404. Latching connections include spring-loaded latches 406 and receivers 408. Frame 312 includes a first three alignment pins (e.g., 402A, 402B, and 402C) which are insertable into a first three alignment holes (e.g., 404A, 404B, and 404C) on first side end 308. Frame 312 includes a second three alignment pins (e.g., 402D, 402E, and 402F) which are insertable into a second three alignment holes (e.g., 404D, 404E, and 404F) on second side end 310. Frame 312 includes a pair of alignment pins (e.g., 402H and 402G) which are insertable into a pair of alignment holes (e.g., 404H and 404G) on frame front surface 306.

Latching connection of connection points 314 include spring-loaded latches 406 and receivers 408. Frame 312 includes a first two receivers (e.g., 408A, 408B) which are configured to receive a first two spring-loaded latches (e.g., 406A, 406B) on the first side end 308. Frame 312 includes a second two receivers (e.g., 408C, 408D) which are configured to receive a second two spring-loaded latches (e.g., 406C, 406D) on the second side end 310. Frame 312 includes three receivers (e.g., 408E, 408F, 408G) which are configured to receive three spring-loaded latches (e.g., 406E, 406F, 406G) on frame front end 306. Frame front surface 306 includes a first two receivers (e.g., 408H, 408I) which are configured to receive a first two spring-loaded latches (e.g., 406H, 406I) on the first side end 308. Frame front surface 306 includes a second two receivers (e.g., 408J, 408K) which are configured to receive a second two spring-loaded latches (e.g., 406J, 406K) on the second side end 310.

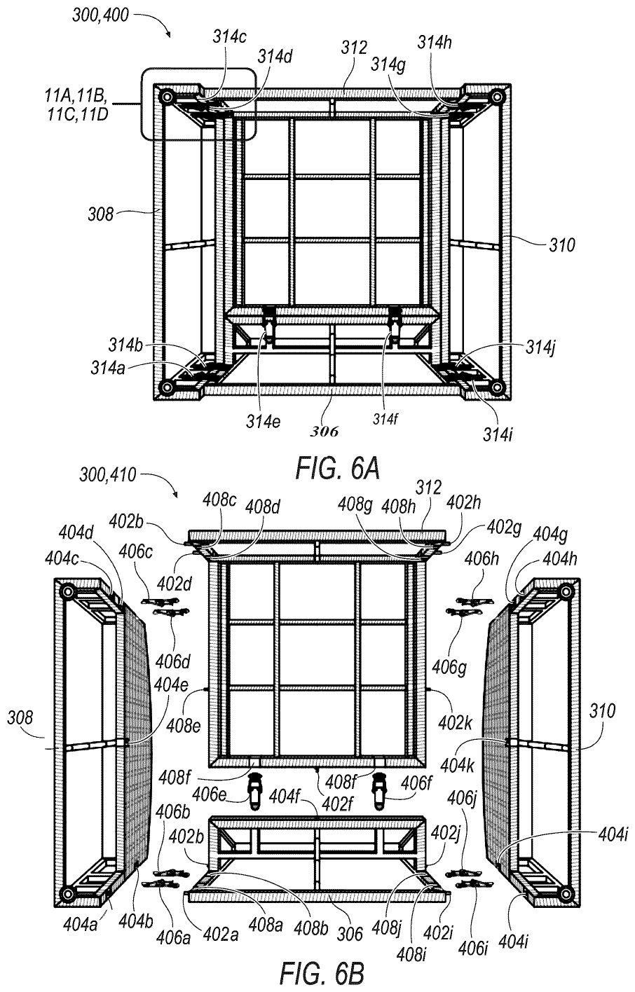

FIG. 6A illustrates an exemplary sofa 300 in an assembled positioned 400 from a bottom view and FIG. 6B illustrates an exemplary sofa 300 in a disassembled position 410 from a bottom view. As shown in FIG. 6A, first side end 308, second side end 310, frame 312, and frame front surface 306 are connected at connection points 314. In the exemplary configuration, first side end 308 is connected to frame 312 via connection points 314C, 314D and is connected to frame front surface 306 via connection point 314A, 314B. Second side end 310 is connected to frame 312 via connection points 3146, 314H and is connected to frame front surface 306 via connection points 314J, 314I. Frame front surface 306 is connected to frame 312 (e.g., at seat bottom 304) via connection points 314E, 314F. Each connection point may include at least one alignment connection and at least one latching connection, however more than one may be used to strengthen the assembly of each piece.

As illustrated in FIG. 6B, connection points 314 include alignment connections and latching connections. For example, alignment connections include alignment pins 402, and alignment holes 404. Latching connections include spring-loaded latches 406 and receivers 408. Frame 312 includes a first three alignment pins (e.g., 402C, 402D, 402E) which are insertable into a first three alignment holes (e.g., 404C, 404D, 404E) on first side end 308. Frame 312 includes a second three alignment pins (e.g., 402G, 402H, 402K) which are insertable into a second three alignment holes (e.g., 404G, 404H, 404K) on second side end 310. Frame 312 includes an alignment pin (e.g., 402F) which is insertable into an alignment hole (e.g., 404F) on frame front surface 306.

Latching connections of connection points 314 include spring-loaded latches 406 and receivers 408. Frame 312 includes a first two receivers (e.g., 408C, 408D) which are configured to receive a first two spring-loaded latches (e.g., 406C, 406D) on the first side end 308. Frame 312 includes a second two receivers (e.g., 408G, 408H) which are configured to receive a second two spring-loaded latches (e.g., 406G, 406H) on the second side end 310. Frame 312 includes two receivers (e.g., 408E, 408F) which are configured to receive two spring-loaded latches (e.g., 406E, 406F) on frame front end 306. Frame front surface 306 includes a first two receivers (e.g., 408A, 408B) which are configured to receive a first two spring-loaded latches (e.g., 406A, 406B) on the first side end 308. Frame front surface 306 includes a second two receivers (e.g., 408I, 408J) which are configured to receive a second two spring-loaded latches (e.g., 406I, 406J) on the second side end 310.

According to the disclosure, frame 312 includes at least three alignment pins 402 insertable into each of the pair of side ends 308, 310 and the frame front surface 306, such that only three alignment pins 402 are necessary in frame 312, however more alignment connections may be added and used. In configurations, frame front surface 310 includes at least two alignment pins 402 insertable into each of pair of side ends 308, 310, such that only two alignment pins 402 are necessary in frame front surface 306, however more alignment connections may be added and used. Alignment pins 402 and alignment holes 404 are provided for case of aligning each of disassembled pieces such that they may be positioned and secured in a correct position.

According to the disclosure, frame 312 includes at least three receivers 408 configured to receive at least three spring-loaded latches 406, one latch 406 positioned on each of each side end of the pair of side ends 308, 310 and the front frame surface 306, such that only three receivers 408 are necessary in frame 312, however more latching connections may be added or used. In configurations, frame front surface 310 includes at least two receivers 408 configured to receive at least two spring-loaded latches 406, one latch 406 positioned on each side end of the pair of side ends 308, 310, such that only two receivers 408 are necessary in frame front surface 310, however more latching connections may be added or used.

Thus, according to an embodiment, wherein the furniture piece is configured as a sofa, 300, the furniture piece includes the frame 312 having the seat back 302 and the seat bottom 304, the pair of side ends 308, 310 removably attached to opposing sides of the frame 312, and the frame front surface 306 removably attached to a front side of the frame 312. The frame 312 includes at least three alignment pins 402 and at least three receivers 408. Each side end of the pair of side ends 308, 310 includes at least two alignment pins 402 and at least two spring-loaded receivers 408. The frame front surface 306 includes at least two alignment pins 402, at least one alignment hole 404, at least two receivers 408, and at least one spring-loaded latch 406. In an assembled position, each of the at least three alignment pins 402 of the frame 312 are inserted into a respective alignment hole 404 of the at least two alignment holes 404 of each side end 308, 310 and the at least one alignment hole 404 of the front frame surface 306. Each of the at least three receivers 408 of the frame 312 are latched by the at least two spring-loaded latches 406 of each side end 308, 310 and the at least one spring-loaded latch 406 of the front frame surface 306. Each of the at least two receivers 408 of the front frame surface 306 are latched by the at least two spring-loaded latches 406 of each side end 308, 310. Each of the at least two alignment pins 402 of the front frame surface 306 are inserted into the at least two alignment holes 404 of each side end 308, 310.

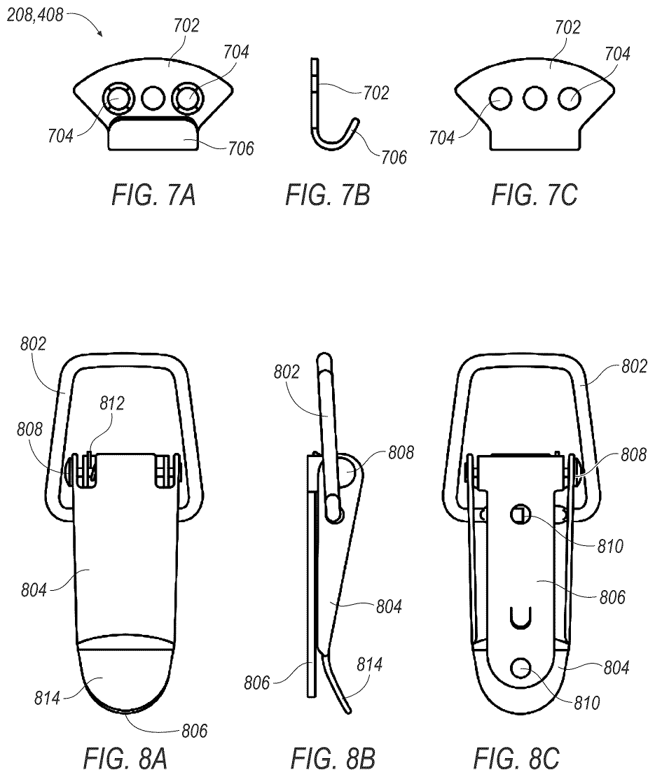

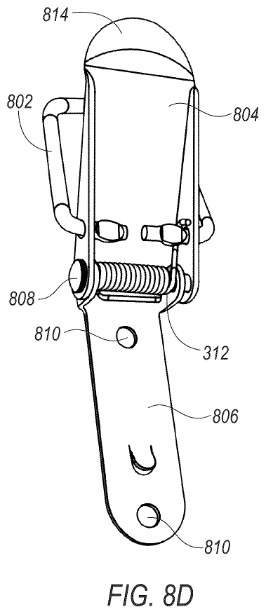

FIGS. 7A-7C illustrate an exemplary receiver 208, 408 (e.g., a catch plate). The receiver 208, 408 includes a backplate 702. The backplate 702 is attached to the furniture pieces at connection points 314 via apertures 704 and screws (not shown) or other attachment mechanisms. The receiver 208, 408 includes an integrated protruding lip 706 from a bottom edge of the backplate 702. The protruding lip 706 extends from the backplate 702 to receive the spring-loaded latch 706. The receiver 208, 408 may, in some examples, be made of metal or plastic. FIGS. 8A-8C illustrate an exemplary spring-loaded latch 206, 406 (e.g., a chest latch) for use with receiver 208, 408. The latch includes a backplate 806 for connecting to the furniture pieces at connections points 314 via apertures 810 and screws (not shown) or other attachment mechanisms. The latch 206, 406 includes an arm 802 which may be a metal rod and generally has a rectangular shape. A handle 804 is rotatable about an axis 808. In a closed position, the handle 804 extends such that it generally covers a the backplate 806. Handle 804 include a concave portion 814 which extends from the end of the handle 804 for a user to grasp with case. Arm 802 is connected to handle 804 such that as handle 804 moves, arm 802 may travel with handle 804. Axis 808 includes a spring 812 that provides tension to the handle. When the latch 206, 406 is in an open position (see, e.g., FIG. 8D), handle 802 is in an extended position, rotated about axis 808 away from backplate 806. In the open position, the tension is free. and arm 802 may move. In the closed position (see, e.g., FIGS. 8A-8C), handle 802 is in a collapsed position, such that the handle 802 is adjacent to backplate 806. Tension from spring 812 is created and arm 804 remains hooked in position.

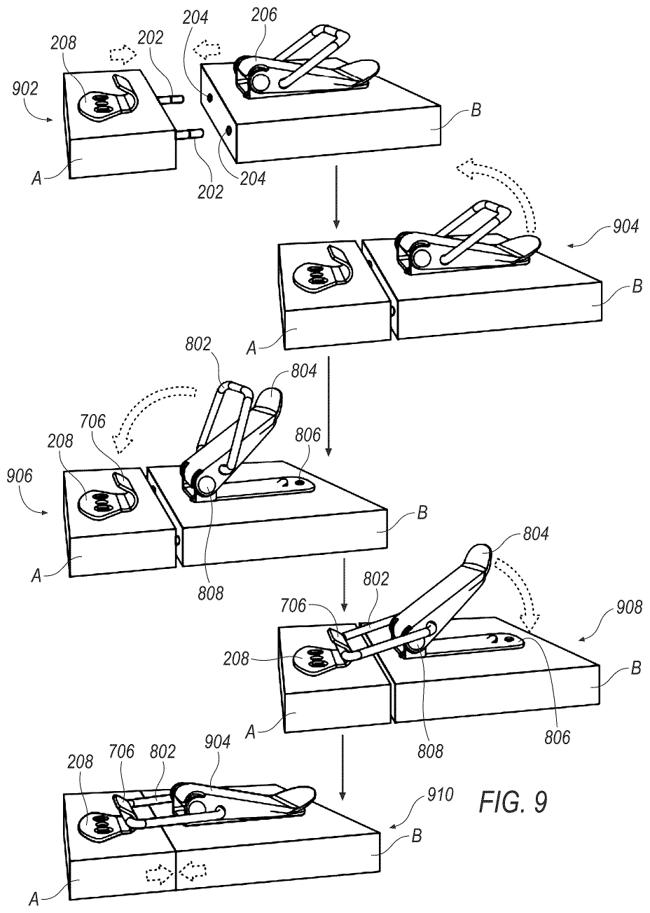

Referring to FIG. 9, an illustrated flowchart or schematic of using the latch mechanism is illustrated. At 902, furniture piece A and furniture piece B are space apart. Alignment pins 202 are aligned with alignment holes 204 such that furniture piece A and furniture piece B may be pushed together to form a selectively connectable and dis-connectable furniture system 910 having a reusable latch arrangement. Latch 206 is in a closed position. At 904, alignment pins 202 of furniture piece A have been inserted into alignment holes 204 of furniture piece B and the pieces A. B have been pushed together. At 906, the handle 804 may be opened via rotating handle 804 about axis 808. At 908, the arm 802 is rotated such that it is latched in the receiver 208 and positioned around lip 706. At system 910, the handle 804 has been rotated back around axis 808 to a closed position against backdrop 806. In the closed position, spring 812 has created tension, pulling furniture piece A and furniture piece B closely together and securing the pieces. The system 910 is easily connectable and dis-connectable based on how a user may want to use furniture.

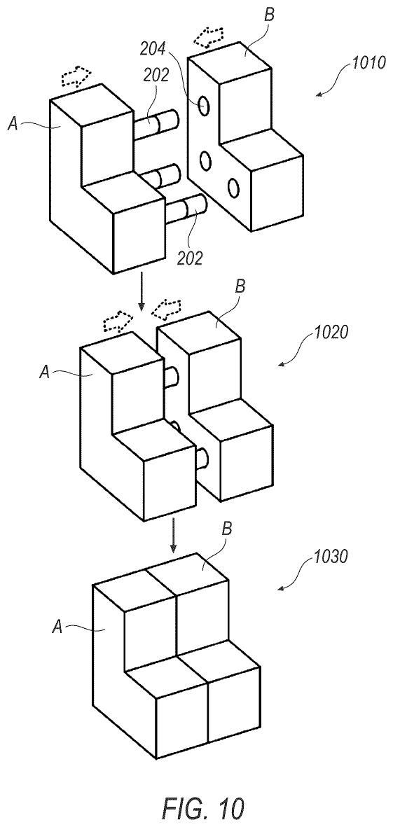

Referring to FIG. 10, an illustrated flowchart of using the alignment mechanism is shown. At 1010, furniture piece A and furniture piece B are space apart. Alignment pins 202 are aligned with alignment holes 204 such that furniture piece A and furniture piece B may be pushed together. At 1020, furniture piece A is pushed together with furniture piece B. Alignment pins 202 are inserted into alignment holes 204. Alignment pins 202 have a circumference generally equal to circumference of alignment holes 204 such that pins 202 fit into holes 204 but do not easily fall out of holes 204. At 1030, furniture piece A and furniture piece B are fully pushed together and secured. A selectively align able system is provided that can be used in conjunction with the system 910.

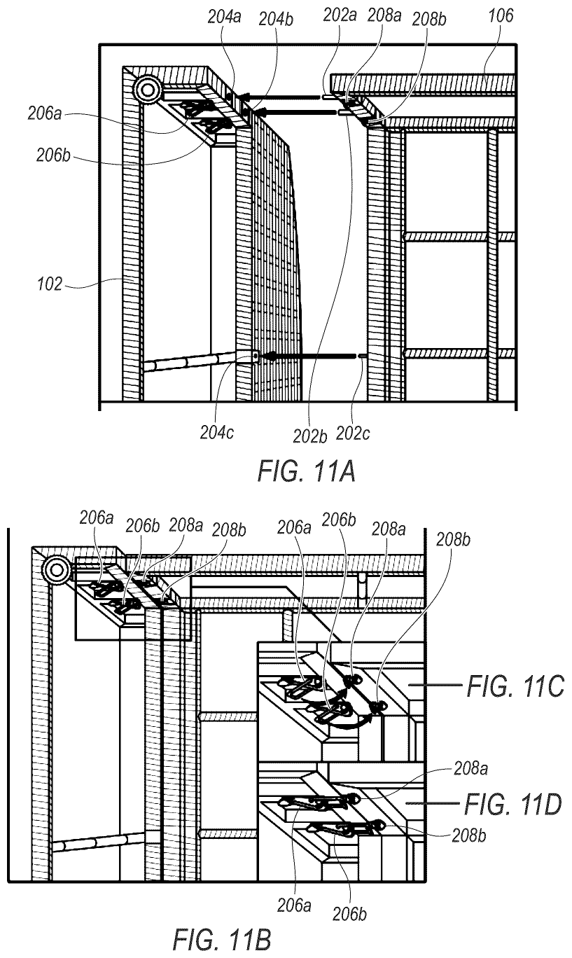

Referring to FIGS. 11A-11D, an illustrated method of assembling a piece of furniture is shown with regard to the circled portion of the assembled furniture 300, 400 illustrated in FIG. 6A. As illustrated in FIG. 11A, a frame 106 is being connected to a first side end 102. The plurality of alignment pins 202A, 202B, 202C located on frame 106 are aligned with the plurality of alignment holes 204A, 204B, 202C located on the first side end 102. In FIG. 11B, the frame 106 has been pushed together with the first side end 102 such that the alignment pins 202A. 202B, 202C have been inserted into the alignment holes 204A, 204B, 204C on the first side end 102. As illustrated in FIG. 11C, the latches 206A, 206B are being moved to an open position such that the handle 804 is rotated about axis 808. As illustrated in FIG. 11D, the arm has been positioned around the lip 706 of receivers 208A, 208B and the handle 804 has been rotated back to a closed position. The frame 106 and the first side end 102 are secured at the illustrated connection points 110.

Thus, the method of assembling a piece of furniture includes aligning a first side end 102 with a first side of a frame 106, inserting a plurality of alignment pins 202 on the first side of the frame 106 into a plurality of alignment holes 204 on the first side end 102, latching a plurality of spring-loaded latches 206 on the first side end 102 with a plurality of receivers 208 on the first side of the frame 106, aligning a second side end 104 with a second side of the frame 106, inserting a plurality of alignment pins 202 on the second side of the frame 106 into a plurality of alignment holes 204 on the second side end 104, and latching a plurality of spring-loaded latches 206 on the second side end 104 with a plurality of receivers 208 on the second side of the frame 106.

In configurations where the furniture is a table, the method may further include inserting a plurality of alignment pins 202 on a bottom surface of a tabletop 108 into a plurality of alignment holes 204 on a top surface of the frame 106 and then latching a plurality of spring-loaded latches 206 on the tabletop 108 to a plurality of receivers 208 on the frame 106.

In configurations where the furniture is a chair, the method may further includes inserting a plurality of alignment pins 402 on the first side of the front frame surface 306 into a plurality of alignment holes 404 on the first side end 308, inserting a plurality of alignment pins 402 on a second side of the frame front surface 306, opposite the first side, into a plurality of alignment holes 404 on the second side end 310, and inserting a plurality of alignment pins 402 on a third side of the frame 312, perpendicular to the first side and the second side of the frame 312, into a plurality of alignment holes 404 on a third side of the frame front surface 306, perpendicular to the first side and the second side of the front frame surface 306. method further includes then latching a plurality of spring-loaded latches 406 on the first side end 308 to a plurality of receivers 408 on the first side of the front frame surface 306, latching a plurality of spring-loaded latches 406 on the second side end to a plurality of receivers 408 on the second side of the front frame surface 306, and latching a plurality of spring-loaded latches 406 on the third side of the front frame surface 306 to a plurality of receivers on the third side of the frame 312.

Thus, according to the disclosure, a furniture piece includes a table having a tabletop and a frame and a pair of side ends removably attached to opposing sides of the frame. The frame includes at least two alignment pins and at least two receivers. Each side end of the pair of side ends includes at least one alignment hole and at least one spring-loaded latch. When the frame and the pair of side ends are in an assembled position, an alignment pin of the at least two alignment pins are insertable into a respective alignment hole of the at least two alignment holes, and a spring-loaded latch of the at least one spring-loaded latch is positioned such that the latch is tight around a receiver of the at least one receiver.

Also, according to the disclosure, a furniture piece includes a frame having a seat back and a seat bottom, a pair of side ends removably attached to opposing sides of the frame, and a frame front surface. The seat back and the seat bottom include at least three alignment pins and at least three receivers. Each side end of the pair of side ends includes at least two alignment holes and at least two spring-loaded latches. The frame front surface includes at least two alignment pins, at least one alignment hole, at least two receivers, and at least one spring-loaded latch. When the frame, the pair of side ends, and the frame front surface are in an assembled position, each alignment pin is insertable in a respective alignment hole, and each receiver is receivable in a respective spring-loaded latch.

According to the disclosure, a method of assembling a furniture piece includes aligning a first side end with a first side of a frame, inserting a plurality of alignment pins on the first side into a plurality of alignment holes on the first side end, latching a plurality of spring-loaded latches on the first side end with a plurality of receivers on the first side of the frame, aligning a second side end with a second side of the frame, inserting a plurality of alignment pins on the second side into a plurality of alignment holes on the second side end and latching a plurality of spring-loaded latches on the second side end with a plurality of receivers on the second side of the frame.

While embodiments of the invention have been described, it is not intended that these embodiments illustrate and describe all possible forms of the invention. Rather, the words used in the specification are words of description rather than limitation, and it is understood that various changes may be made without departing from the spirit and scope of the invention.

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description, but is only limited by the scope of the appended claims.

What is claimed is:

1. A furniture piece, comprising:
a table having a tabletop and a frame;
the frame including:
at least two alignment pins; and
at least two receivers; and
a pair of side ends removably attached to opposing sides of the frame;
each side end of the pair of side ends including:
at least one alignment hole; and
at least one spring-loaded latch;
wherein, when the frame and the pair of side ends are in an assembled position, an alignment pin of the at least two alignment pins is insertable into a respective alignment hole of the at least two alignment holes; and
a spring-loaded latch of the at least one spring-loaded latch is positioned such that the latch is secured around a receiver of the at least one receiver.

2. The furniture piece of claim 1, wherein the tabletop is removably attached to the frame.

3. The furniture piece of claim 1, wherein a bottom surface of the tabletop includes at least two alignment pins that are insertable into at least two alignment holes on a top surface of the frame.

4. The furniture piece of claim 1, wherein the frame includes four alignment pins, and the pair of side ends includes four alignment holes;
a first two alignment pins are positioned on a first side of the frame and a second two alignment pins are positioned on a second side of the frame, opposite the first side;
a first two alignment holes positioned on a first side end of the pair of side ends and a second two alignment holes positioned on a second side end of the pair of side ends; and
the first two alignment pins are insertable into the first two alignment holes; and
the second two alignment pins are insertable into the second two alignment holes.

5. The furniture piece of claim 1, wherein the at least one alignment hole includes an inner circumference that is equal to the outer circumference of an alignment pin of the at least two alignment pins.

6. The furniture piece of claim 4, wherein the frame includes four receivers, and the pair of side ends include four spring-loaded latches;
a first two receivers positioned on the first side of the frame and a second two receivers positioned on the second side of the frame;
a first two spring-loaded latches positioned on the first side end of the pair of side ends and a second two spring-loaded latches positioned on the second side end of the pair of side ends; and
the first two spring-loaded latches are connectable to the first two receivers; and
the second two spring-loaded latches are connectable to the second two receivers.

7. The furniture piece of claim 1, wherein, in the assembled position, the first two receivers are connected to the first two spring-loaded latches, the second two spring-loaded latches are connected to the second two spring-loaded latches, the first two alignment pins are inserted into the first two alignment holes, and the second two alignment pins are inserted into the second two alignment holes.

8. A furniture piece, comprising:
a frame having a seat back and a seat bottom;
the seat back and the seat bottom including:
at least three alignment pins; and
at least three receivers;
a pair of side ends removably attached to opposing sides of the frame;
each side end of the pair of side ends including:
at least two alignment holes; and
at least two spring-loaded latches; and
a frame front surface;
the frame front surface having:
at least two alignment pins;
at least one alignment hole;
at least two receivers; and
at least one spring-loaded latch;
wherein, when the frame, the pair of side ends, and the frame front surface are in an assembled position, each alignment pin is insertable in a respective alignment hole, and each receiver is receivable in a respective spring-loaded latch.

9. The furniture piece of claim 8, wherein the length of the frame and the length of the frame front surface are equal; and
the length of the frame and the length of the frame front surface are extendable.

10. The furniture piece of claim 8, further comprising a back cushion and a bottom cushion;
wherein the back cushion and the bottom cushion are positionable against the seat back and the seat bottom in the assembled position.

11. The furniture piece of claim 8, wherein:
the frame includes at least seven alignment pins; and
each side end of the pair of side ends includes three alignment holes.

12. The furniture piece of claim 11, wherein:
a first three alignment pins of the at least seven alignment pins are positioned on a first side of the frame and are insertable into the three alignment holes of a first side end of the pair of side ends;
a second three alignment pins of the at least seven alignment pins are positioned on a second side of the frame, opposite the first side, and are insertable into the three alignment holes of a second side end of the pair of side ends; and
at least one alignment pin of the at least seven alignment pins are positioned on a third side of the frame, perpendicular to the first side and the second side, and is insertable into the at least one alignment hole of the frame front surface.

13. The furniture piece of claim 12, wherein:
the frame includes at least six receivers;
each side end of the pair of side ends includes at least four spring-loaded latches; and
the frame front surface includes at least four receivers and at least two spring-loaded latches.

14. The furniture piece of claim 13, wherein:
a first two receivers of the at least six receivers of the frame are connectable to a first two spring-loaded latches of the at least four spring-loaded latches of the first side end;
a second two receivers of the at least six receivers of the frame are connectable to a first two spring-loaded latches of the at least four spring-loaded latches of the second side end;
a third two receivers of the at least six receivers of the frame are connectable to the at least two spring-loaded latches of the frame front surface;
a second two spring-loaded latches of the at least four spring-loaded latches of the first side end are connectable to a first two receivers of the at least four receivers of the frame front surface; and
a second two spring-loaded latches of the at least four spring-loaded latches of the second side end are connectable to a second two receivers of the at least four receivers of the frame front surface.

15. The furniture piece of claim 14, wherein, in the assembled position, the first two receivers of the frame are connected to the first two spring-loaded latches of the first side end, the second two receivers of the frame are connected to the first two spring-loaded latches of the second side end, the third two receivers of the frame are connected to the at least two spring-loaded latches of the frame front surface, the second two spring-loaded latches of the first side end are connected to the first two receivers of the frame front surface, and the second two spring-loaded latches of the second side end are connected to the second two receivers of the frame front surface.

16. A method of assembling a furniture piece, comprising:
aligning a first side end with a first side of a frame;
inserting a plurality of alignment pins on the first side into a plurality of alignment holes on the first side end;
latching a plurality of spring-loaded latches on the first side end with a plurality of receivers on the first side of the frame;
aligning a second side end with a second side, opposite the first side, of the frame;
inserting a plurality of alignment pins on the second side into a plurality of alignment holes on the second side end; and
latching a plurality of spring-loaded latches on the second side end with a plurality of receivers on the second side of the frame.

17. The method of claim 16, further comprising:
inserting a plurality of alignments pins on a bottom surface of a tabletop into a plurality of alignment holes on a top surface of the frame.

18. The method of claim 17, further comprising:
latching a plurality of spring-loaded latches on the tabletop to a plurality of receivers on the frame.

19. The method of claim 16, further comprising:
inserting a plurality of alignment pins on a first side of a front frame surface into a plurality of alignment holes on the first side end;
inserting a plurality of alignment pins on a second side of the front frame surface, opposite the first side of the front frame surface, into a plurality of alignment holes on the second side end; and
inserting a plurality of alignment pins on a third side of a frame, perpendicular to the first side and the second side of the front frame surface, into a plurality of alignment holes on a third side of a front frame surface, perpendicular to the first side and the second side of the front frame surface.

20. The method of claim 19, further comprising:
latching a plurality of spring-loaded latches on the first side end to a plurality of receivers on the first side of the front frame surface;
latching a plurality of spring-loaded latches on the second side end to a plurality of receivers on the second side of the front frame surface; and
latching a plurality of spring-loaded latches on the third side of the front frame surface to a plurality of receivers on the third side of the frame.
